(19) United States
(12) Patent Application Publication
(10) Pub. No.: US 2008/0265209 A1
(43) Pub. Date: Oct. 30, 2008

(54) RED PHOSPHOR COMPOSITION AND METHOD OF PREPARING THE SAME

(75) Inventors: Jeong Seog Kim, Chungcheongnam-do (KR); Chae Cheon, Seoul (KR); Ki Woong Chae, Chungcheongnam-do (KR)

Correspondence Address: LARSON AND LARSON, 11199 69TH STREET NORTH, LARGO, FL, 33773, US

(73) Assignee: HOSEO UNIVERSITY ACADEMIC COOPERATION FOUNDATION, Chungcheongnam-do (KR)

(21) Appl. No.: 11/965,719

(22) Filed: Dec. 27, 2007

(30) Foreign Application Priority Data
Apr. 25, 2007 (KR) 10-2007-0040257

(51) Int. Cl. C09K 11/77

(52) U.S. Cl. 252/301.4 R

(57) ABSTRACT

The invention relates to a red phosphor composition and a method of preparing the same, and more particularly, a red phosphor which includes Al₂O₃ as a main component and contains Cr₂O₃, Cr₃O₄, or CrO as a primary active agent and at least one element selected from Eu, Pr, Fe, Ce, and Sm as a secondary active agent. The red phosphor has an emission wavelength band of 650-750 nm and can provide high chromatic purity for red light and high light emission efficiency.

### BACKGROUND OF THE INVENTION

1. Field of the Invention

The present invention relates to a red phosphor composition and a method of preparing the same, and more particularly, to a red phosphor composition which can be used in the manufacture of electronic display devices or panels and contains Al₂O₃ as a main component and Cr₂O₃, Cr₃O₄, or CrO as an active agent.

2. Description of the Prior Art

In general, phosphors are prepared by mixing high-purity raw materials and flux and plasticizing the resulting mixture in a furnace at a temperature of 1000-1700° so as to induce a solid-phase reaction. The commercialization of red phosphors requires phosphors that can be manufactured at low cost and can provide high luminance and high chromatic purity.

White light-emitting diodes (LEDs), which have been widely used as backlight elements for liquid crystal displays (LCDs) of various electronic devices such as lighting devices, laptop computers and mobile phones, include the combination of red, green and blue LEDs or the combination of blue/ultraviolet (UV) LEDs and other various phosphors. An example of a phosphor for use in white LEDs, i.e., a YAG:Ce phosphor, is disclosed in Korean Patent Laid-Open Gazette No. 2000-49728. The YAG:Ce phosphor, which has been patented worldwide by Nichia Corporation, is being widely used not only by domestic companies but also by international companies. However, the YAG:CE phosphor has a limited excitation wavelength of 450 nm and thus may not be suitable for use in various LEDs.

In the meantime, U.S. Pat. No. 6,621,211 discloses a method of generating white light by mixing red, green and blue phosphors, Korean Patent Laid-Open Gazette No. 2003-0089947 discloses a method of generating white light by applying a (1-x)Al₂O₃SiO₂: Eu²⁺ₓ phosphor to a UV-LED, and Korean Patent Laid-Open Gazette No. 2003-0053919 discloses a red phosphor for long wavelength UV, i.e., LiW₂O₄:Eu,Sm. LiW₂O₄:Eu,Sm has high emission luminance. However, LiW₂O₄:Eu,Sm has a limited excitation wavelength band of 350-400 nm and thus may not be suitable for use in blue LEDs.

(Y,Gd)BO₃:Eu has been commercialized as a red phosphor for use in LEDs and plasma display panels (PDPs). However, (Y,Gd)BO₃:Eu has low chromatic purity. Various red phosphors such as Y(V, P)O₄:Eu⁺³ for use in PDPs or fluorescent lamps and SrTiO₃:Pr, Y₂O₃:Eu, and Y₂O₃S:Eu for use in field emission displays (FEDs), cathode ray tubs (CRTs), and vacuum fluorescent displays (VFDs) have been developed. These red phosphors, however, still have a limited emission wavelength of 610 nm and thus have low chromatic purity and low light emission efficiency.

### SUMMARY OF THE INVENTION

In order to address the problems associated with conventional red phosphors such as a limited excitation wavelength band, a limited emission wavelength band and low chromatic purity, the present invention provides preparing a red phosphor using a mixture of materials which is easy to acquire and has a different composition from that of a matrix phase or an active agent of a conventional red phosphor.

The present invention also provides preparing a red phosphor, which can provide higher chromatic purity for red light and a narrower emission wavelength band than a conventional red phosphor by being excited by a light source that emits light having a short wavelength band (i.e., an ultraviolet (UV) band) of 120-200 nm and a blue wavelength band of 350-460 nm.

The present invention also provides preparing a red phosphor which can provide excellent red light-emitting properties even at a vacuum UV (VUV) wavelength of 130-200 nm, high chromatic purity for red light, and higher light emission efficiency than a conventional red phosphor in terms of an excitation wavelength band and an emission wavelength band.

The present invention also provides preparing a red phosphor which can achieve excellent light emission intensity properties by using not only Cr but also Ce, Eu, Pr, Mn, Sm or Fe as an active agent and can allow an emission wavelength band to be appropriately adjusted according to the type and the amount of the active agent used.

The present invention also provides preparing a red phosphor which can be mixed with a conventional red phosphor and can thus allow the chromatic purity of red light, an emission wavelength band and the intensity of the emission of red light to be appropriately adjusted.

According to an aspect of the present invention, there is provided a red phosphor composition including Al₂O₃ as a main component and Cr as an active agent, the red phosphor composition being represented by the following formula:

Al₂O₃:xCr

wherein x indicates mole (0.000003≦x≦0.3) and Cr is the combination of at least one selected from Cr⁴⁺, Cr³⁺ and Cr²⁺ According to another aspect of the present invention, there is provided a red phosphor composition including Al₂O₃ as a main component, Cr as a primary active agent, and at least one element selected from Ce, Eu, Pr, Gd, Sm, Tb, Nd, Er, Ho, Fe and Mn as a secondary active agent, the red phosphor composition being represented by the following formula:

Al₂O₃:xCr,yM

wherein x indicates mole (0.000003≦x≦0.3), Cr is the combination of at least one selected from Cr⁴⁺, Cr³⁺ and Cr²⁺, y also indicates mole (0.0000003≦y≦0.2), and M is the combination of at least one element selected from Ce, Eu, Pr, Gd, Sm, Tb, Nd, Er, Ho, Fe and Mn. According to another aspect of the present invention, there is provided a red phosphor composition including Al₂O₃ and at least one selected from SiO₂, MgO, WO₃, QO₂ and SrTiO₃ as main components and containing Cr as a primary active agent and at least one element selected from Ce, Eu, Pr, Gd, Sm, Tb, Nd, Er, Ho, Fe and Mn as a secondary active agent, the red phosphor composition being represented by the following formula:

Al₂O₃-tSiO₂-uMgO-vWO₃-wQ₂O₃-zCaTiO₃:xCr,yM

wherein t, u, v, w, z, x, and y indicate mole (0.0≦t≦0.3, 0.0≦u≦0.3, 0.0≦v≦0.3, 0.0≦w≦0.3, 0.0≦z≦0.4, 0.000003≦x≦0.3, 0.0000003≦:y≦0.2), Q is the combination of at least one monovalent alkali metal selected from K, Na, Li and Cs, Cr is the combination of at least one selected from Cr⁴⁺, Cr³⁺ and Cr²⁺, and M is the combination of at least one element selected from Ce, Eu, Pr, Gd, Sm, Tb, Nd, Er, Ho, Fe and Mn.

According to another aspect of the present invention, there is provided a red phosphor composition including Al₂O₃ and at least one selected from AlN and Si₃N₄ as a main components and containing Cr as a primary active agent and at least one element selected from Ce, Eu, Pr, Gd, Sm, Tb, Nd, Er, Ho, Fe and Mn as a secondary active agent, the red phosphor composition may be represented by the following formula:

Al₂O₃vAlNwSi₃N₄:xCr,yM

wherein v, w, x, and y indicate mole (0.0≦v≦0.3, 0.0≦w≦0.3, 0.000003≦x≦0.3, 0.0000003≦:y≦0.2), Cr is the combination of at least one selected from Cr⁴⁺, C³⁺ and Cr²⁺, and M is the combination of at least one element selected from Ce, Eu, Pr, Gd, Sm, Tb, Nd, Er, Ho, Fe and Mn.

According to another aspect of the present invention, there is provided a method of preparing a red phosphor composition, the method including mixing a mixture of at least one of a nano-sized Al-containing oxide, an Al-containing organic compound, an Al-containing inorganic compound, a chromium-containing compound, a Eu-containing compound, a Pr-containing compound, a Fe-containing compound, and an alkali compound in one flux selected from ethanol, isopropylene alcohol, distilled water, and water; drying the mixture in an oven at a temperature of 80-300° for 2-4 hours; and plasticizing the dried mixture in a high-purity alumina boat at a plasticizing temperature of 500-1750° for 0.5-16 hours.

### BRIEF DESCRIPTION OF THE DRAWINGS

The above and other aspects and features of the present invention will become more apparent by describing in detail exemplary embodiments thereof with reference to the attached drawings, in which:

FIG. 1A illustrates a flowchart of a method of preparing a red phosphor according to an embodiment of the present invention;

FIG. 1B illustrates a flowchart of a method of preparing a red phosphor according to another embodiment of the present invention;

FIG. 2 illustrates a graph of the X-ray diffraction (XRD) pattern of a red phosphor (Al₂O₃:0.06Cr₂O₃) obtained using Formula 1 according to an embodiment of the present invention;

FIG. 3 illustrates a graph of the ultraviolet (UV)-photoluminescence (PL) (absorption/emission) spectrum of Al₂O₃:0.06Cr₂O₃;

FIG. 4 illustrates a graph of the UV-PL (absorption/emission) spectrum of a red phosphor (Al₂O₃:0.03Cr₂O₃) obtained using Formula 1;

FIG. 5 illustrates a graph of the PL spectrum of a commercial red phosphor (Ba₂Mg(PO₄)₂:0.1 Eu0.1(0.02Ce));

FIG. 6 illustrates a graph of the vacuum UV (VUV)-PL (absorption/emission) spectrum of Al₂O₃:0.06Cr₂O₃;

FIG. 7 illustrates a graph of the XRD pattern of raw material powder according to an embodiment of the present invention;

FIG. 8 illustrates a graph of the VUV-PL (absorption/emission) spectrum of Al₂O₃:0.03Cr₂O₃;

FIG. 9 illustrates a graph of the VUV-PL spectrum of Ba₂Mg(PO₄)₂:0.1Eu0.1(0.02Ce);

FIG. 10 illustrates a graph of the XRD pattern of a red phosphor (Al₂O₃:0.06Eu₂O₃) for comparison with Al₂O₃:0.06Cr₂O₃ and Al₂O₃:0.03Cr₂O₃; and

FIG. 11 illustrates a graph of the PL (absorption/emission) spectrum of Al₂O₃: 0.06Eu₂O₃.

### DETAILED DESCRIPTION OF THE PREFERRED EMBODIMENT

The present invention will now be described more fully with reference to the accompanying drawings, in which exemplary embodiments of the invention are shown.

According to a first embodiment of the present invention, a red phosphor having Al₂O₃ as a main component and containing Cr as an active agent is provided.

The composition of the red phosphor of the first embodiment may be represented by Formula 1:

Al₂O₃:xCr

wherein x indicates mole (0.000003≦x≦0.3) and Cr is the combination of at least one selected from Cr⁴⁺, Cr³⁺ and Cr²⁺.

A red phosphor having Al₂O₃ as a main component may be interpreted as being an aluminum oxide-based red phosphor which mainly includes Al and O. Conventional red phosphors contain Li₂WO₄, LiEuW₂O₄, (Y,Gd)BO₃, Y(V,P)O₄, SrTiO₃, Y₂O₃, or Y₂O₃S as a main component and realize red light using Eu or Pr as an active element. However, conventional red phosphors having Li, W, Y, B, P, Sr, Ti, or O as a main component generally emit light having a wavelength of about 610 nm and thus provide low chromatic purity for red light and low light emission efficiency. Thus, the inventors of the present invention have developed a red phosphor and a method of preparing a red phosphor using a mixture of materials which has a different composition from that of a conventional red phosphor and contains a different active agent from that of a conventional red phosphor.

The red phosphor of the first embodiment, which has Al₂O₃ as a main component and contains Cr as an active agent, may have at least one alumina phase selected from gamma-alumina, beta-alumina, alpha-alumina, corundum, kappa-alumina phases as main phases, and this may become apparent with reference to an XRD pattern of the aluminum oxide-based red phosphor.

The red phosphor of the first embodiment emits pure red light having a wavelength of 660-740 nm and provides a narrow peak emission wavelength band of 690-700 nm by being excited by a light source that emits light having a short wavelength band (i.e., a UV band) of 120-200 nm and a blue wavelength band of 350-460 nm. In addition, the red phosphor of the first embodiment can provide excellent red light-emitting properties even at a VUV wavelength of 130-200 nm. In short, the red phosphor of the first embodiment can provide higher chromatic purity for red light and higher light emission efficiency than conventional red phosphors which provide a limited excitation/emission wavelength band of 610 nm.

An Al-containing compound used in the first embodiment may include at least one selected from aluminum hydroxide, aluminum nitrate, aluminum chlorate, and aluminum acetate. A Cr-containing compound used in the first embodiment may include at least one selected from chromium hydroxide, chromium nitrate, chromium chlorate, and chromium acetate. The Cr-containing compound may be added to the Al-containing compound such that the mole ratio of the Cr-containing compound to the Al-containing compound can become within the range of 0.003-0.1.

According to a second embodiment of the present invention, a red phosphor having Al₂O₃ as a main component and containing Cr as a primary active agent and at least one element selected from Ce, Eu, Pr, Gd, Sm, Tb, Nd, Er, Ho, Fe and Mn as a secondary active agent may be provided. The composition of the red phosphor of the second embodiment may be represented by Formula 2:

Al₂O₃:xCr,yM

wherein x indicates mole (0.000003≦x≦0.3), Cr is the combination of at least one selected from Cr⁴⁺, Cr³⁺ and Cr²⁺, y also indicates mole (0.0000003≦y≦0.2), and M is the combination of at least one element selected from Ce, Eu, Pr, Gd, Sm, Tb, Nd, Er, Ho, Fe and Mn.

Since the red phosphor of the second embodiment has Al₂O₃ as a main component and contains Cr as a primary active agent and Ce, Eu, Pr, Mn, or Fe as a secondary active agent, the red phosphor of the second embodiment can provide high red light emission intensity. That is, the red phosphor of the second embodiment, like the red phosphor of the first embodiment, has an alumina crystal structure and can emit pure red light having a wavelength of 650-750 nm and provides a narrow peak emission wavelength band of 690-700 nm by being excited by a light source that emits light having a short wavelength band (i.e., a UV band) of 120-200 nm and a blue wavelength band of 350-480 nm.

Ce, Eu, Fe, Pr, or Mn which can be contained in the red phosphor of the second embodiment as a secondary active agent may be added to an alumina-based compound such that the mole ratio of whichever of Ce, Eu, Fe, Pr, and Mn is contained in the red phosphor of the second embodiment as the secondary active agent to the alumina-based compound can become within the range of 0.00003-0.1. The emission wavelength band of the red phosphor of the second embodiment may be varied by controlling the type, the amount of use and the concentration of the secondary active agent. In this manner, it is possible to selectively achieve a desired chromatic purity and a desired luminance level.

According to a third embodiment of the present invention, a red phosphor having Al₂O₃ and at least one selected from SiO₂, MgO, WO₃, QO₂ and SrTiO₃ as main components and containing Cr as a primary active agent and at least one element selected from Ce, Eu, Pr, Gd, Sm, Tb, Nd, Er, Ho, Fe and Mn as a secondary active agent is provided. The composition of the red phosphor of the third embodiment may be represented by Formula 3:

Al₂O₃-tSiO₂-uMgO-vWO₃-wQ₂O₃-zCaTiO₃:xCr,yM

wherein t, u, v, w, z, x, and y indicate mole (00≦t≦0.3, 0.0≦u≦0.3, 0.0≦v≦0.3, 0.0≦w≦0.3, 0.0≦z≦0.4, 0.000003≦x≦0.3, 0.0000003≦:y≦0.2), Q is the combination of at least one monovalent alkali metal selected from K, Na, Li and Cs, Cr is the combination of at least one selected from Cr⁴⁺, Cr³ and Cr², and M is the combination of at least one element selected from Ce, Eu, Pr, Gd, Sm, Tb, Nd, Er, Ho, Fe and Mn.

The red phosphor of the third embodiment includes Al₂O₃ as a primary main component and either at least one oxide selected from SiO₂, MgO, WO₃, QO₂ and SrTiO₃ or a carbonate as a secondary main component. Thus, the red phosphor of the third embodiment can improve the efficiency of the emission of red light and the chromatic purity for red light and provide various chromatic purity and luminance levels. The red phosphor of the third embodiment, like the red phosphor of the second embodiment, contains Cr as a primary active agent and at least one element selected from Ce, Eu, Pr, Gd, Sm, Tb, Nd, Er, Ho, Fe and Mn as a secondary active agent. In order to prepare the red phosphor of the third embodiment, SiO₂, MgO, WO₃, QO₂ and/or SrTiO₃ may be weighed at a predetermined composition ratio and then uniformly mixed with Al₂O₃ using ball milling or a mortar.

Like the red phosphor of the first embodiment, the red phosphor of the third embodiment has alumina as a main component, has a corundum structure, and is characterized by having an emission wavelength band of 650-750 nm (peak emission wavelength: 690-700 nm) when excited by a light source that emits light having a short wavelength band (i.e., a UV band) of 120-200 nm and a blue wavelength band of 350-480 nm.

According to a fourth embodiment of the present invention, a red phosphor having Al₂O₃, and at least one selected from AlN and Si₃N₄ as main components and containing Cr as a primary active agent and at least one element selected from Ce, Eu, Pr, Gd, Sm, Tb, Nd, Er, Ho, Fe and Mn as a secondary active agent may be provided. The composition of the red phosphor of the fourth embodiment may be represented by Formula 4:

Al₂O₃vAlNwSi₃N₄:xCr,yM

wherein v, w, x, and y indicate mole (0.0≦v≦0.3, 0.0≦w≦0.3, 0.000003≦x≦0.3, 0.0000003≦:y≦0.2), Cr is the combination of at least one selected from Cr⁴⁺, C³⁺ and Cr², and M is the combination of at least one element selected from Ce, Eu, Pr, Gd, Sm, Tb, Nd, Er, Ho, Fe and Mn.

The red phosphor of the fourth embodiment has Al₂O₃ as a primary main component and at least one nitride selected from AlN and Si₃N₄ as a secondary main component. Due to AlN and/or Si₃N₄, the red phosphor of the fourth embodiment can improve the efficiency of the emission of red light and the chromatic purity for red light and affect the chromatic purity and luminance of light. The red phosphor of the fourth embodiment also contains Cr as a primary active agent and at least one selected from Ce, Eu, Pr, Gd, Sm, Tb, Nd, Er, Ho, Fe and Mn. In order to prepare the red phosphor of the fourth embodiment, AlN and/or Si₃N₄ may be weighed at a predetermined composition ratio and then uniformly mixed with Al₂O₃ using ball milling or a mortar.

Like the red phosphor of the first embodiment, the red phosphor of the fourth embodiment has alumina as a main component, has a corundum structure, and is characterized by having an emission wavelength band of 650-750 nm (peak emission wavelength: 690-700 nm) when excited by a light source that emits light having a short wavelength band (i.e., a UV band) of 120-200 nm and a blue wavelength band of 350-480 nm.

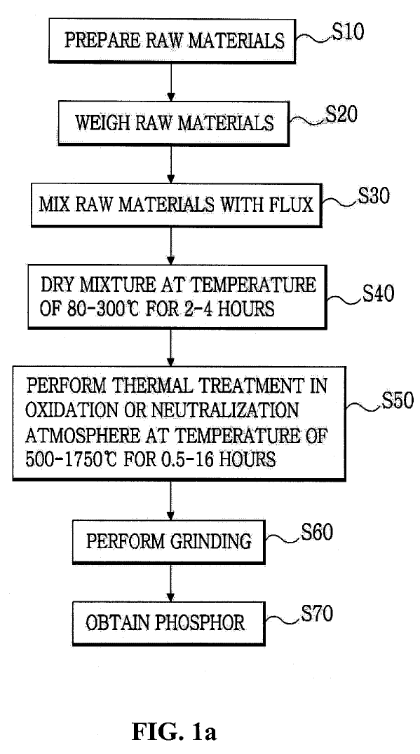

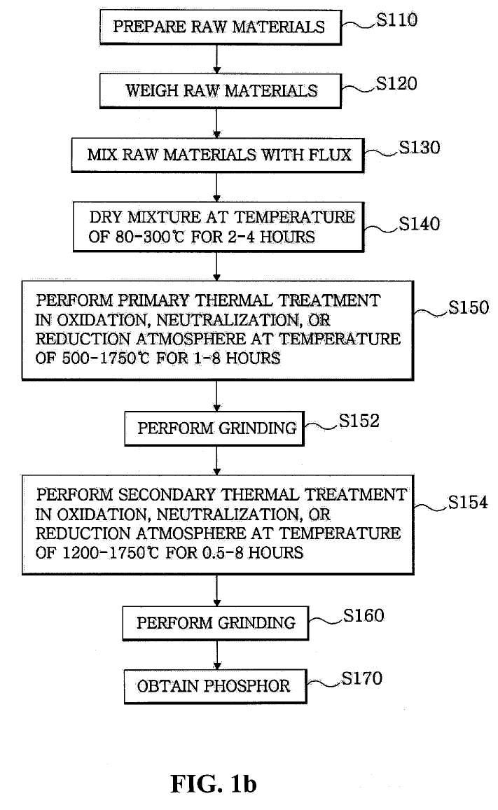

FIG. 1A illustrates a flowchart of a method of preparing a red phosphor according to an embodiment of the present invention, and FIG. 1B illustrates a flowchart of a method of preparing a red phosphor according to another embodiment of the present invention.

Referring to FIG. 1A, raw materials are prepared (S10) and then weighed (S20). The mixture of at least one selected from an Al-containing oxide, an Al-containing organic compound, an Al-containing inorganic compound, a chromium-containing compound, a Eu-containing compound, a Pr-containing compound, a Fe-containing compound, and an alkali compound is mixed in one flux selected from ethanol, isopropylen alcohol, distilled water or water (S30). The mixture obtained in operation S30 is dried in an oven at a temperature of 80-300° for 2-4 hours (S40). The dried mixture is plasticized in a high-purity alumina boat in an atmosphere of air or oxygen at a plasticizing temperature of 500-1750° for 0.5-16 hours (S50).

Operation S50 may be performed in two stages, as illustrated in FIG. 1B. More specifically, referring to FIG. 1B, the dried mixture is plasticized in a high-purity alumina boat in an atmosphere of at least one of air, oxygen, nitrogen, an argon gas, hydrogen and a vacuum at a plasticizing temperature of 500-1750° for 1-8 hours (S150). Then, the result of the plasticization is grinded (S152). Thereafter, the result of the grinding is plasticized in an atmosphere of air or oxygen at a temperature of 1200-1750° for 0.5-8 hours (S154).

The methods of the embodiments of FIGS. 1A and 1B have been described above, taking the preparation of the red phosphor having the composition of Formula 2 as an example. However, the methods of the embodiments of FIGS. 1A and 1B can also be applied to the fabrication of the red phosphors having the compositions of Formulas 1, 3 and 4.

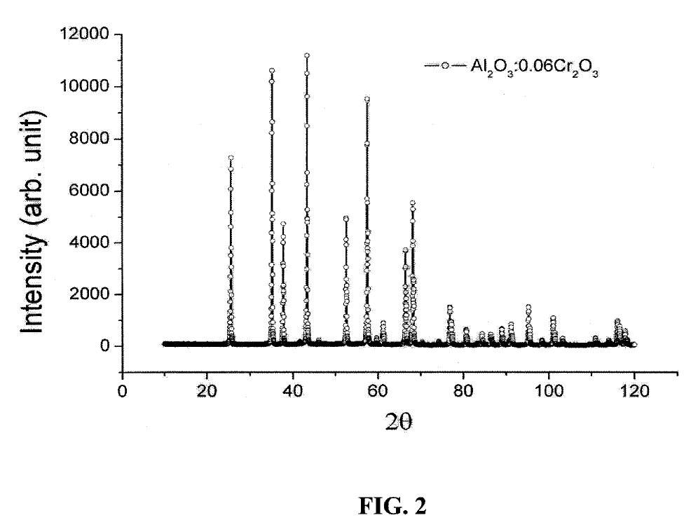

Red phosphors having the compositions of Formulas 1, 2, 3 and 4 may be prepared using a solid-phase reaction method, as illustrated in FIGS. 1 and 2. Alternatively, red phosphors having the compositions of Formulas 1, 2, 3 and 4 may be prepared using various methods such as a sol-gel method, which involves extracting solid materials from a solution of a metal organic compound, chloride, nitride, and hydroxide, a pyrolysis method, and a crystal growth method. Still alternatively, red phosphors having the compositions of Formulas 1, 2, 3 and 4 may be prepared by growing a monocrystalline or polycrystalline structure and grinding the monocrystalline or polycrystalline structure, i.e., by using the Bridgman method, the Czochralski method, zone growing method, and a flux method.

Red phosphors having the compositions of Formulas 1, 2, 3 and 4 have an excitation wavelength band of 120-200 nm and an emission wavelength band of 650-750 nm for an excitation wavelength band of 350-480 nm. In addition, red phosphors having the compositions of Formulas 1, 2, 3 and 4 provide more excellent emission luminance properties than conventional UV-excited red phosphors. The peak excitation wavelength and peak emission wavelength of red phosphors having the compositions of Formulas 1, 2, 3 and 4 may vary according to the compositions of the red phosphors and the types of raw materials of and the types of elements added to the red phosphors. Red phosphors having the compositions of Formulas 1, 2, 3 and 4 may be used together with conventional red phosphors or red phosphors whose development is under way and may thus allow the chromatic purity of red light, an emission wavelength band, and the intensity of the emission of red light to be appropriately adjusted. The red phosphors having the compositions of Formulas 1, 2, 3 and 4 may be used in various fields of industry such as the fields of blue light-emitting diodes (LEDs), liquid crystal display (LCD) backlights, fluorescent lamps, and plasma panel display phosphors.

### Embodiment 1

### Red phosphor Al₂O₃:yCr₂O₃ (y=0.003, 0.06) (Formula 1)

### Embodiment 1-1

A red phosphor, i.e., Al₂O₃:0.003Cr₂O₃, was obtained by performing a thermal treatment as illustrated in FIG. 1A. Specifically, 0.003 mole of Cr₂O₃ powder was added to nano-sized Al₂O₃ powder, and then the mixture was heat-treated once at a temperature of 1200° for 4 hours. Thereafter, the result of the heat treatment was ground to obtain Al₂O₃:0.003Cr₂O₃.

### Embodiment 1-2

A red phosphor, i.e., Al₂O₃:0.003Cr₂O₃, was obtained by performing two thermal treatments as illustrated in FIG. 1B. Specifically, 0.003 mole of Cr₂O₃ powder was added to nano-sized Al₂O₃ powder, and then the mixture was heat treated in the air at a plasticizing temperature of 1350° for 4 hours. Then, the result of the first heat treatment was ground and mixed, and then heat treated in the air at a temperature of 1600° for 5 hours to obtain Al₂O₃:0.003Cr₂O₃.

### Embodiment 1-3

A red phosphor, i.e., Al₂O₃:0.06Cr₂O₃, was obtained by performing two thermal treatments as illustrated in FIG. 1B. Specifically, 0.06 mole of Cr₂O₃ powder was added to nano-sized Al₂O₃ powder, and then the mixture was heat treated in the air at a plasticizing temperature of 1350° for 4 hours. Then, the result of the first heat treatment was ground and mixed, and then heat treated in the air at a temperature of 1600° for 5 hours to obtain Al₂O₃:0.06Cr₂O₃.

FIG. 2 illustrates a graph of the X-ray diffraction (XRD) pattern of the red phosphor of Embodiment 1-3, i.e., Al₂O₃:0.06Cr₂O₃. Referring to FIG. 2, Al₂O₃:0.06Cr₂O₃ has an alumina phase (JCPDS No. 43-1483 or 42-1468) which is commonly known as corundum, alundum or alpha-alumina and has a unique structure, and the characteristics of the alumina phase are as follows: a rhombohedral crystal structure (space group R-3c); a trigonal crystal system; a=b=c=5.13°; and α=β=γ=55.280. A raw material added to Al₂O₃:0.06Cr₂O₃ as an active agent, i.e., Cr₂O₃, does not appear on the XRD pattern of Al₂O₃:0.06Cr₂O₃ due to being fused in the alumina. The alumina phase may be a phosphor having a crystal structure similar to that of a kappa-alumina phase (ICDS No. 8584).

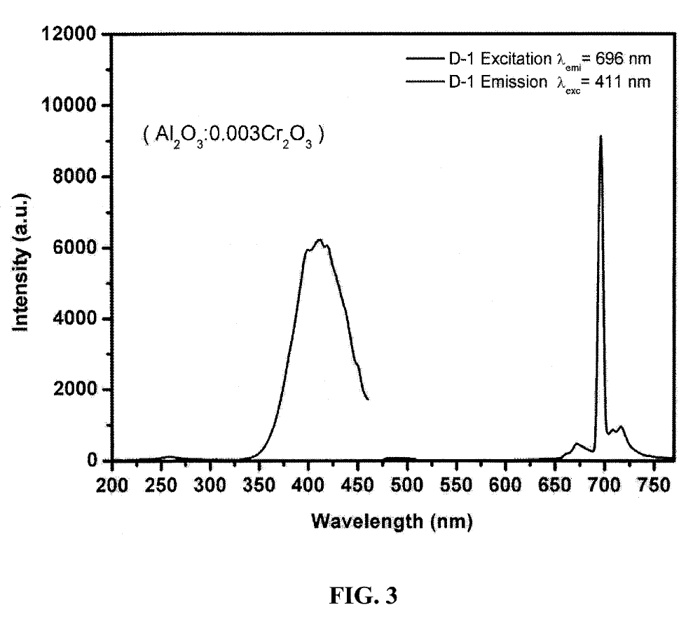

FIG. 3 illustrates a graph of the photoluminescence (PL) spectrum of the red phosphor of Embodiment 1-3, i.e., Al₂O₃:0.06Cr₂O₃. Referring to FIG. 3, Al₂O₃:0.06Cr₂O₃ of Embodiment 1-3 has an excitation wavelength band of 350-460 nm (peak excitation wavelength: 398 nm), an emission wavelength band of 650-750 nm (peak emission wavelength: 695 nm).

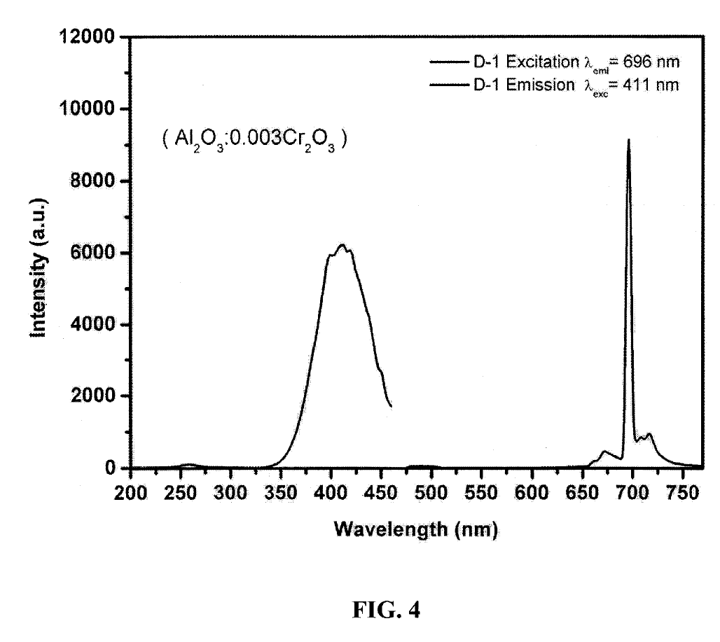

FIG. 4 illustrates a graph of the PL spectrum of the red phosphor of Embodiment 1-1, i.e., Al₂O₃:0.003 Cr₂O₃. Referring to FIG. 4, Al₂O₃:0.003 Cr₂O₃ has an excitation wavelength band of 360-450 nm (peak excitation wavelength: 411 nm) and an emission wavelength band of 650-750 nm (peak emission wavelength: 696 nm).

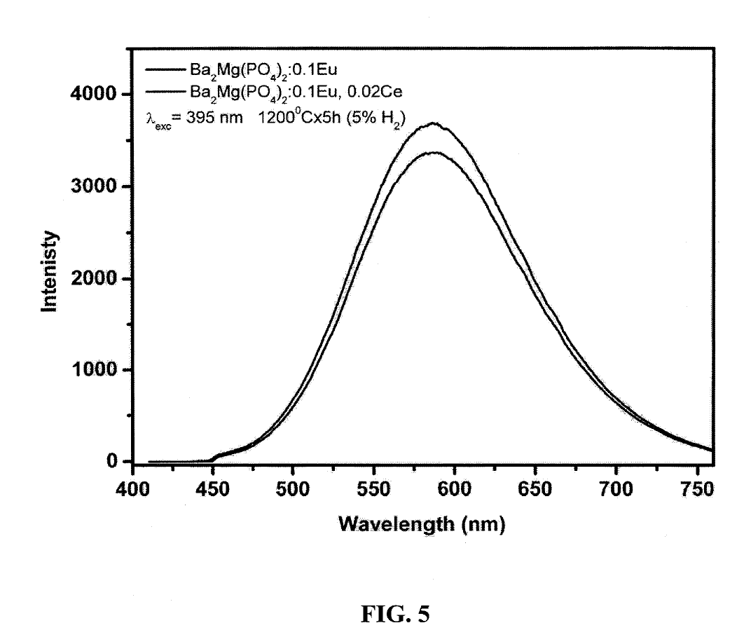

FIG. 5 illustrates a graph of the PL spectrum of a commercial red phosphor, i.e., Ba₂Mg(PO₄)₂:0.1Eu0.1 (0.02Ce), for comparison with a red phosphor according to an embodiment of the present invention. Referring to FIG. 5, Ba₂Mg(PO₄)₂:0.1Eu0.1(0.02Ce) has an emission wavelength band of 500-700 nm and includes light-emitting components of various colors such as green, yellow, and red. Therefore, Ba₂Mg(PO₄)₂:0.1Eu0.1(0.02Ce) provides even lower chromatic purity than a red phosphor according to an embodiment of the present invention.

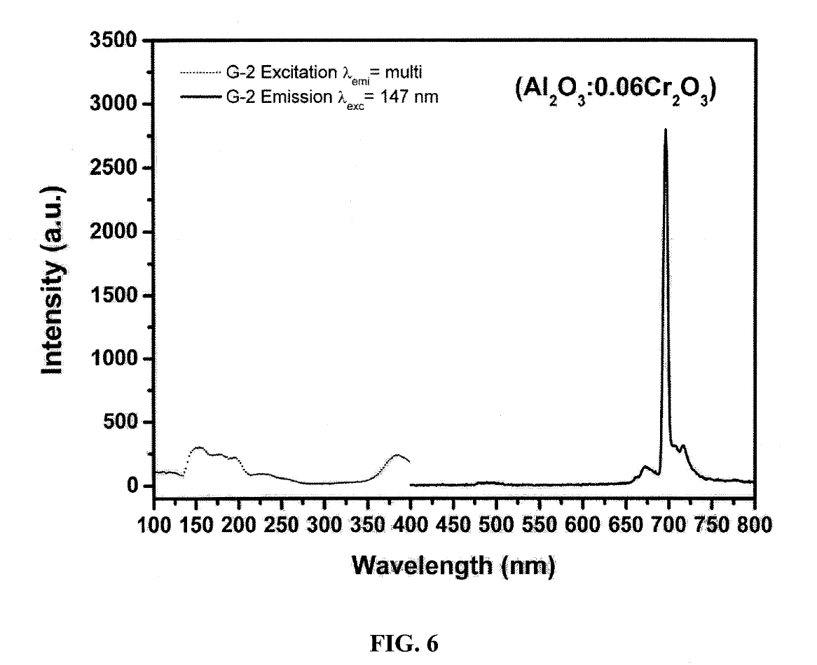

FIG. 6 illustrates a graph of the VUV-PL spectrum of the red phosphor of Embodiment 1-3, i.e., Al₂O₃:0.06Cr₂O₃. Referring to FIG. 6, Al₂O₃:0.06Cr₂O₃ of Embodiment 1-3 has an excitation wavelength band of 120-210 nm (peak excitation wavelength: 147 nm) and an emission wavelength band of 660-740 nm (peak emission wavelength: 698 nm).

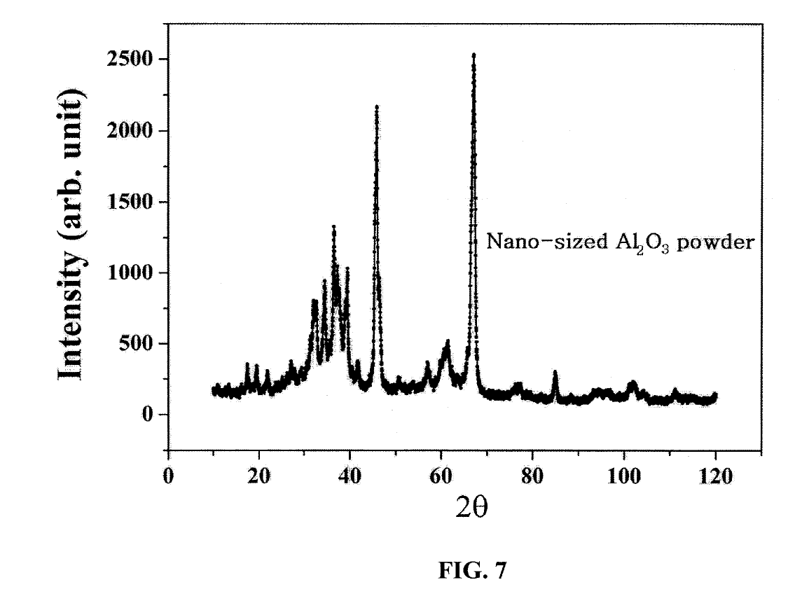

FIG. 7 illustrates a graph of the XRD pattern (CuKa target, wavelength=0.154 nm) of nano-sized alumina powder used in the preparation of the red phosphor of Embodiment 1-3, i.e., Al₂O₃:0.06Cr₂O₃. Referring to FIG. 7, the alumina powder has theta-alumina phase (JCPDS No. 23-1009, 11-0517: monoclinic structure, a=1.2 nm, b=0.27 nm, c=0.55 nm, β=103°).

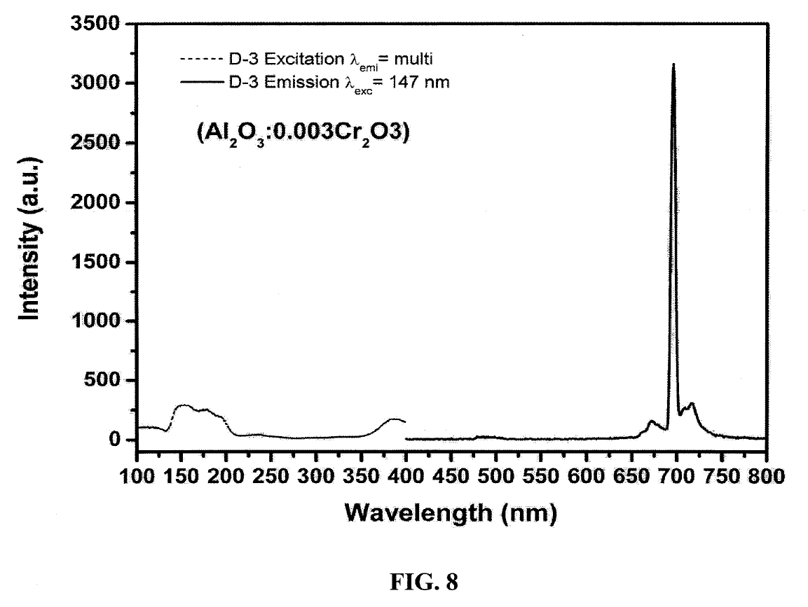

FIG. 8 illustrates a graph of the VUV-PL spectrum of the red phosphor of Embodiment 1-2, i.e., Al₂O₃:0.03 Cr₂O₃. Referring to FIG. 8, Al₂O₃:0.03 Cr₂O₃, like the red phosphor of Embodiment 1-3 (i.e., Al₂O₃:0.06Cr₂O₃), has an excitation wavelength band of 120-210 nm (peak excitation wavelength: 147 nm) and an emission wavelength band of 660-740 nm (peak emission wavelength: 698 nm).

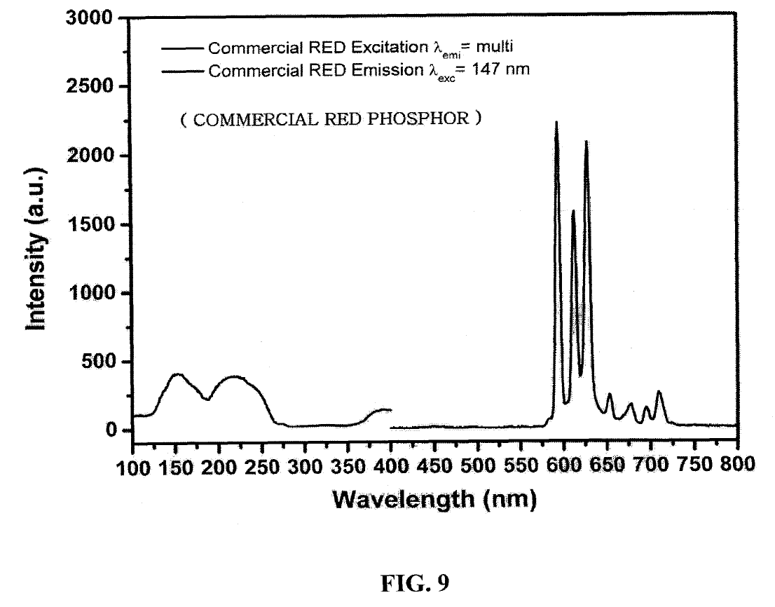

FIG. 9 illustrates a graph of the VUV-PL spectrum of the commercial red phosphor of FIG. 5, i.e., Ba₂Mg(PO₄)₂:0.1Eu0.1(0.02Ce), for comparison with a red phosphor according to an embodiment of the present invention.

Referring to FIG. 9, Ba₂Mg(PO₄)₂:0.1Eu0.1(0.02Ce) has an excitation wavelength band of 130-260 nm. Ba₂Mg(PO₄)₂:0.11Eu0.1(0.02Ce) has a peak excitation wavelength of 147 nm which is the same as that of the red phosphor of Embodiment 1-3, i.e., Al₂O₃:0.06Cr₂O₃. However, Al₂O₃:0.06Cr₂O₃ has an emission wavelength band of 660-740 nm, whereas Ba₂Mg(PO₄)₂:0.1Eu0.1(0.02Ce) has an emission wavelength band of 570-630 nm. Thus, Al₂O₃:0.06Cr₂O₃ provides more excellent chromatic purity properties for red light than Ba₂Mg(PO₄)₂:0.11Eu0.1(0.02Ce). That is, Ba₂Mg(PO₄)₂:0.11Eu0.1(0.02Ce) emits light having a wavelength of 570-630 nm, which may not necessarily be pure red light in terms of chroma and hue. However, Al₂O₃:0.06Cr₂O₃ emits almost pure red light and can thus provide more excellent chromatic properties than Ba₂Mg(PO₄)₂:0.1Eu0.1(0.02Ce).

Table 1 shows chromatic purity properties of red phosphors according to embodiment of the present invention, i.e., Al₂O₃:xCr₂O₃ (where x=0.003, 0.03, or 0.06) obtained by using nano-sized alumina powder and Cr₂O₃ powder as raw materials and using Formula 1.

TABLE 1
CIE xy Coordinates of Phosphors (Al₂O₃:yCr₂O₃)

| | Peak Excitation | Peak Emission | |
|---|---|---|---|
| Red Phosphor | Wavelength | Wavelength | CIE xy |
| Composition | (nm) | (nm) | Coordinates |
| Al₂O₃:0.003Cr₂O₃ | 411 | 696 | 0.61, 0.28 |
| Al₂O₃:0.03Cr₂O₃ | 397 | 696 | 0.61, 0.28 |
| Al₂O₃:0.06Cr₂O₃ | 410 | 696 | 0.61, 0.29 |

### Comparative Example 1

### Preparation of Red Phosphor (Al₂O₃:yEu₂O₃ where y=0.06)

Nano-sized Al₂O₃ powder and a raw material, i.e., Eu₂O₃, were weighed as illustrated in FIG. 1B, thereby obtaining the composition of Al₂O₃:0.06Eu. Then, the composition of Al₂O₃:0.06Eu was uniformly mixed in ethanol for more than 3 hours by using ball milling and a mortar. Thereafter, the resulting mixture was dried in an oven at a temperature of 80° for 2-3 hours. Thereafter, the dried mixture was put in a high-purity alumina boat and then plasticized at a temperature of 1350° for 5 hours using an electric furnace. Then, the result of the first plasticization was ground. The ground mixture was then plasticized in an electric furnace at a temperature of 1600° for 5 hours, and the result of the second plasticization was ground to obtain a red phosphor. The first plasticization and the second plasticization were performed in the air in order to maintain an oxidation atmosphere.

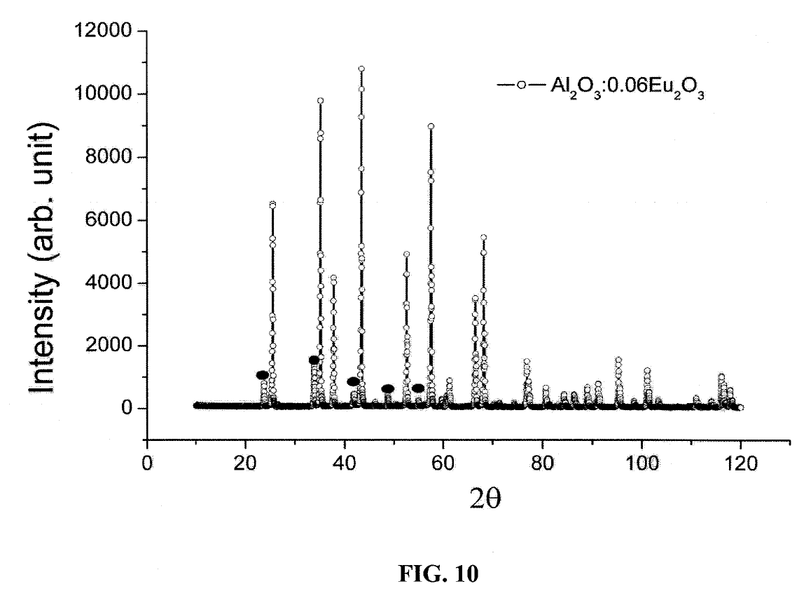

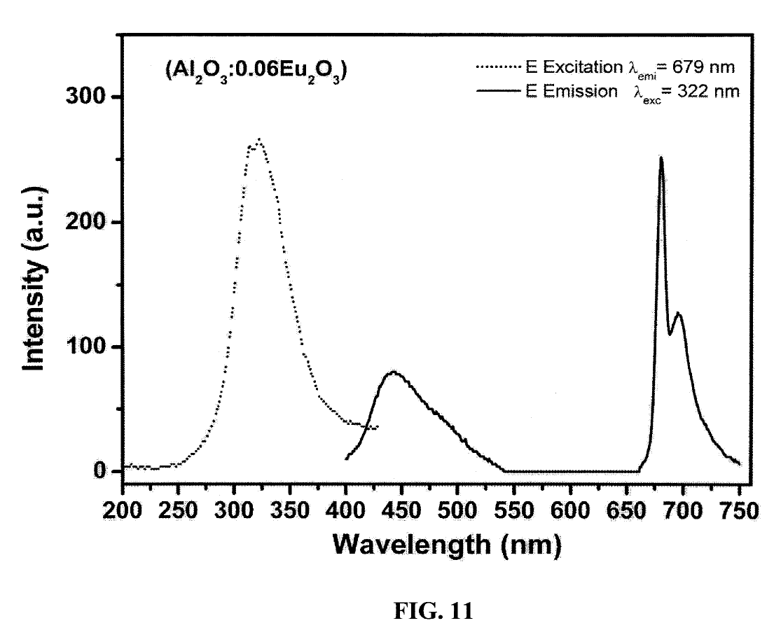

FIG. 10 illustrates a graph of the XRD pattern of the red phosphor of Comparative Example 1, i.e., Al₂O₃:0.06Eu. Referring to FIG. 10, the main phase of A₂O₃:0.06Eu, like those of the red phosphors of Embodiments 1-1 through 1-3, is an alumina phase (JCPDS No. 42-1468) which is commonly known as corundum or alpha-alumina and has a unique structure. A raw material added to Al₂O₃:0.06Eu as an active agent, i.e., Eu₂O₃, does not appear on the XRD pattern of Al₂O₃:0.06Eu due to being partially fused in alumina. However, most Eu₂O₃ reacted with the alumina, thereby resulting in a second phase as indicated by black dots ‘•’ of FIG. 11. The alumina has a crystal structure similar to that of an alumina phase (JCPDS No. 43-1484) commonly known as corundum and that of kappa-alumina phase (ICDS No. 8584).

FIG. 11 illustrates a graph of the PL spectrum of the red phosphor Comparative Example 1, i.e., Al₂O₃:0.06Eu. Referring to FIG. 11, Al₂O₃:0.06Eu has an excitation wavelength band of 270-370 nm (peak excitation wavelength: 322 nm) and emission wavelengths of 420-520 nm and 670-730 nm (peak emission wavelength: 679 nm). By comparing the PL spectrum of Al₂O₃:0.06Eu with the PL spectra of the red phosphors of the embodiments of FIGS. 3 and 4, i.e., Al₂O₃:0.06Cr and Al₂O₃:0.003Cr, it can be seen that the intensity of the emission of light is much lower when using only Eu₂O₃ as an active agent.

As described above, the red phosphor according to the present invention includes an Al₂O₃-based composition as a main component and contains Cr₂O₃, Cr₃O₄, or CrO as an active agent. The raw materials of the red phosphor according to the present invention are easy to acquire, and the red phosphor according to the present invention has a different matrix phase from that of a conventional red phosphor.

In addition, the red phosphor according to the present invention can emit pure red light having a wavelength of 660-740 nm and provide a narrow peak emission wavelength band of 690-700 nm by being excited by a light source that emits light having a short wavelength band (i.e., a UV band) of 120-200 nm and a blue wavelength band of 350-460 nm. The red phosphor according to the present invention can provide excellent red light emission properties even at a VUV wavelength of 130-200 nm. In this regard, the red phosphor according to the present invention is more efficient than conventional red phosphors, which have a limited excitation/emission wavelength band of 610 nm, in terms of chromatic purity for red light and the efficiency of the emission of light.

Moreover, the red phosphor according to the present invention uses not only Cr as a primary active agent but also Eu, Pr, Mn, or Fe as a secondary active agent and can thus provide a high light emission intensity and allow an emission wavelength band to be adjusted according to the type and the amount of use of the secondary active agent. The red phosphor according to the present invention can be used together with a conventional red phosphor and can thus allow the chromatic purity of red light, an emission wavelength band and the intensity of the emission of light to be appropriately adjusted.

The red phosphor according to the present invention can be used in various products such as blue LEDs, white LEDs, UV lamps, PDPs, and fluorescent lamps.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A red phosphor composition comprising Al₂O₃ as a main component and Cr as an active agent, wherein the red phosphor composition being represented by the following formula:
Al₂O₃:xCr
wherein x indicates mole (0.000003≦x≦0.3) and Cr is the combination of at least one selected from Cr⁴⁺, Cr³⁺ and Cr²⁺.

2. A red phosphor composition comprising Al₂O₃ as a main component. Cr as a primary active agent, and at least one element selected from Ce, Eu, Pr, Gd, Sm, Tb, Nd, Er, Ho, Fe and Mn as a secondary active agent, wherein the red phosphor composition being represented by the following formula:
Al₂O₃:xCr,yM
wherein x indicates mole (0.000003≦x≦0.3), Cr is the combination of at least one selected from Cr⁴⁺, Cr³⁺ and Cr²⁺, y also indicates mole (0.0000003≦y≦50.2), and M is the combination of at least one element selected from Ce, Eu, Pr, Gd, Sm, Tb, Nd, Er, Ho, Fe and Mn.

3. A red phosphor composition comprising Al₂O₃ and at least one selected from SiO₂, MgO, WO₃, QO₂ and SrTiO₃ as main components and containing Cr as a primary active agent and at least one element selected from Ce, Eu, Pr, Gd, Sm, Tb, Nd, Er, Ho, Fe and Mn as a secondary active agent, wherein the red phosphor composition being represented by the following formula:
Al₂O₃-tSiO₂-uMgO-vWO₃-wQ₂O₃-zCaTiO₃:xCr,yM
wherein t, u, v, w, z, x, and y indicate mole (0.0≦t≦0.3, 0.0≦u≦0.3, 0.0≦v≦0.3, 0.0≦w≦0.3, 0.0≦z≦0.4, 0.000003≦x≦0.3, 0.0000003≦:y≦0.2), Q is the combination of at least one monovalent alkali metal selected from K, Na, Li and Cs, Cr is the combination of at least one selected from Cr⁴⁺, Cr³ and Cr²⁺, and M is the combination of at least one element selected from Ce, Eu, Pr, Gd, Sm, Tb, Nd, Er, Ho, Fe and Mn.

4. A red phosphor composition comprising Al₂O₃ and at least one selected from AlN and Si₃N₄ as a main components and containing Cr as a primary active agent and at least one element selected from Ce, Eu, Pr, Gd, Sm, Tb, Nd, Er, Ho, Fe and Mn as a secondary active agent, wherein the red phosphor composition may be represented by the following formula:
Al₂O₃vAlNwSi₃N₄:xCr,yM
wherein v, w, x, and y indicate mole (0.0≦v≦0.3, 0.0≦w≦0.3, 0.000003≦x≦0.3, 0.0000003≦:y≦0.2), Cr is the combination of at least one selected from Cr⁴⁺, Cr and Cr²⁺, and M is the combination of at least one element selected from Ce, Eu, Pr, Gd, Sm, Tb, Nd, Er, Ho, Fe and Mn.

5. A method of preparing a red phosphor composition, the method comprising:
mixing a mixture of at least one of a nano-sized Al-containing oxide, an Al-containing organic compound, an Al-containing inorganic compound, a chromium-containing compound, a Eu-containing compound, a Pr-containing compound, a Fe-containing compound and an alkali compound in one flux selected from ethanol, isopropylene alcohol, distilled water, and water;
drying the mixture in an oven at a temperature of 80-300° for 2-4 hours; and
plasticizing the dried mixture in a high-purity alumina boat at a plasticizing temperature of 500-1750° for 0.5-16 hours.

6. The method of claim 5, wherein the plasticizing of the dried mixture further comprising:
plasticizing the dried mixture in a high-purity alumina boat in an atmosphere of at least one of air, oxygen, nitrogen, an argon gas, hydrogen and a vacuum at a plasticizing temperature of 500-1750° for 1-8 hours and grinding the result of the first plasticization; and
plasticizing the result of the grinding in an atmosphere of air or oxygen at a temperature of 1200-1750° for 0.5-8 hours.
